(19) United States
(12) Patent Application Publication
(10) Pub. No.: US 2019/0236473 A1
(43) Pub. Date: Aug. 1, 2019

(54) Autonomous Hybrid Analytics Modeling Platform

(71) Applicant: GE Inspection Technologies, LP, Lewistown, PA (US)

(72) Inventors: Arun Karthi Subramaniyan, Danville, CA (US); Alexandre N. Iankoulski, Lewistown, PA (US); Shyam Sivaramakrishnan, Houston, TX (US); Renato Giorgiani do Nascimento, Americana (BR); Fabio Nonato de Paula, Livermore, CA (US)

(21) Appl. No.: 16/258,489

(22) Filed: Jan. 25, 2019

Related U.S. Application Data
(60) Provisional application No. 62/622,743, filed on Jan. 26, 2018.

(51) Int. Cl. G06N 7/00; G06F 11/34; G06N 20/00

(52) U.S. Cl. CPC G06N 7/00; G06N 20/00; G06F 11/3466

(57) ABSTRACT

In some embodiments, a selection of one or more data tags of a dataset can be received via a graphical user interface (GUI). The data tags can correspond to data in the dataset, and the data can include training data and testing data. A selection of one or more analytics model building techniques can also be received via the GUI. Then, a data processor can build plurality of analytics models using the training data. Each of the one or more selected analytics model building techniques can be used to build at least one analytics model. After building the plurality of analytics models, the data processor can calculate a performance of each of the plurality of analytics models using the testing data. Based on the calculated performance of each of the plurality of analytics models, the GUI can display a comparison of each of the plurality of analytics models.

### CROSS-REFERENCE TO RELATED APPLICATION

The present application claims priority to U.S. Provisional Application No. 62/622,743, filed on Jan. 26, 2018 in the U.S. Patent and Trademark Office, the entire disclosure of which is hereby incorporated by reference.

### BACKGROUND

For the engineer or data analyst, building models from different data sets may come at a time expense, for example, the expense of several hours spend on familiarizing oneself with the data, finding possible correlations and candidate models and features that fit the specific problem statement. In some cases, several time-consuming iterations of model implementation, training and validation may be executed before the analysts can decide on a solution among the techniques known to them.

### SUMMARY

Methods and devices are described herein for implementing an autonomous hybrid analytics modeling platform. In one embodiment, an analytics framework can provide a comprehensive catalog of machine learning, deep learning, probabilistic and hybrid physics techniques. In certain embodiments, a selection of one or more data tags of a dataset can be received via a graphical user interface (GUI). The data tags can correspond to data in the dataset, and the data can include training data and testing data. A selection of one or more analytics model building techniques can also be received via the GUI. Then, a data processor can build plurality of analytics models using the training data. Each of the one or more selected analytics model building techniques can be used to build at least one analytics model. After building the plurality of analytics models, the data processor can calculate a performance of each of the plurality of analytics models using the testing data. Based on the calculated performance of each of the plurality of analytics models, the GUI can display a comparison of each of the plurality of analytics models.

Non-transitory computer program products (i.e., physically embodied computer program products) are also described that store instructions, which when executed by one or more data processors of one or more computing systems, causes at least one data processor to perform operations herein. Similarly, computer systems (e.g., the modeling platform discussed herein) are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The embodiments herein may be better understood by referring to the following description in conjunction with the accompanying drawings in which like reference numerals indicate identically or functionally similar elements, of which

FIG. 1 is an exemplary layout of a graphical user interface (GUI) enabling a user to select data tags and analytics model building techniques for building a plurality of analytics models;

FIG. 2 is a first exemplary layout of the GUI of FIG. 1 displaying a comparison of the generated analytics models;

FIG. 3 is a second exemplary layout of the GUI of FIG. 1 displaying a comparison of the generated analytics models; and

FIG. 4 is a functional block diagram illustrating an exemplary operation of the autonomous hybrid analytics modeling platform.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment. Like reference symbols in the various drawings indicate like elements.

### DETAILED DESCRIPTION

The current subject matter relates to an autonomous hybrid analytics modeling platform (hereinafter “modeling platform”). Some implementations of the current subject matter include an analytics framework that provides a comprehensive catalog of machine learning, deep learning, probabilistic and hybrid physics techniques. The analytics framework benefits from an established user base of data scientist and engineers, and can leverage its own knowledge base to help define the right analytics templates to be employed on the type of uploaded data. An autonomous hybrid analytics machine can suggest different methodologies—classification, ANN, Bayesian Hybrid Models—and set up input/output parameters based on available tags and data type. The intelligence built in the semantic knowledge capture models in the framework can be leveraged to set up parallel model builds, returning the set of best performing models to the user, with minimum user interaction and ready to be deployed.

In some implementations, the current subject matter can enable: autonomous input/output variables selection from dataset provide by user through drag and drop or DB connection methods, with manual selection of inputs and outputs available; autonomous suggestion of models to be built on top of provided data set, with manual down-selection of within available methods provided in a scalable federated hybrid analytics platform; autonomous parallel model build from down-selected set of techniques for further model ranking based on performance; individual model ranking based on performance for each selected output, with model performance comparing functionalities; overall model ranking based on performance for all selected outputs, with model performance comparing functionalities; and/or model quality evaluation through direct comparison of actual and predicted outputs for all models built.

Embodiments of a modeling platform graphical user interface (GUI) are discussed herein below. It is to be understood that the GUI described below and illustrated in the accompanying figures is provided for demonstration purposes. Features of the GUI can be modified in any suitable manner, as would be appreciated by a person of ordinary skill in the art, consistent with the scope of the present claims. Thus, no aspect of the GUI described below and illustrated in the accompanying figures should be treated as limiting the scope of the present disclosure.

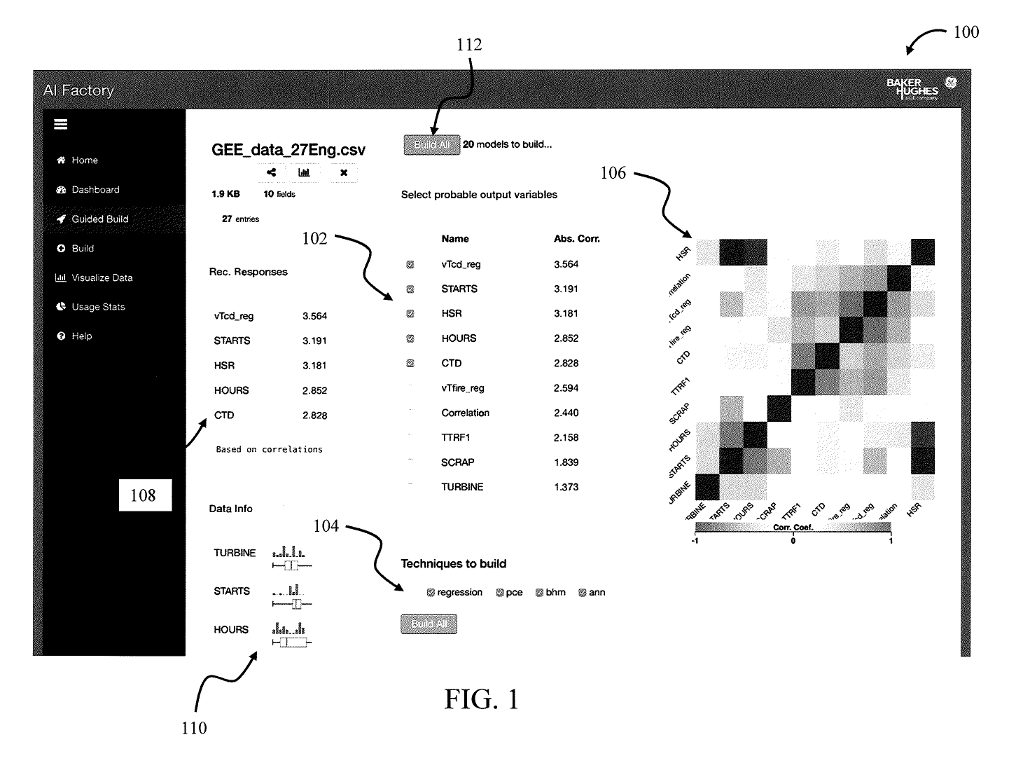

FIG. 1 is an exemplary layout of a GUI 100 enabling a user to select data tags and analytics model building techniques for building a plurality of analytics models. Any type of analytics model can be built including, but not limited to, predictive models, classifier models, image recognition models, natural language processing models, artificial intelligence models, and so forth. These models can be applied toward any variety of application, such as industrial equipment monitoring, weather prediction, stock price prediction, image recognition, and so forth.

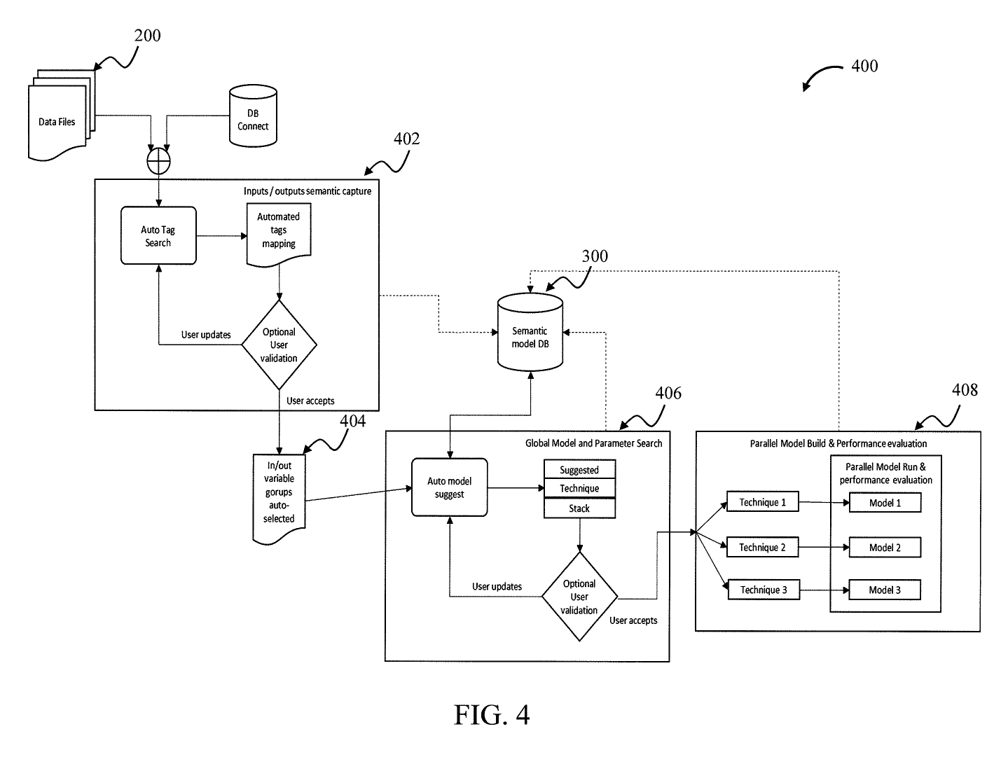

Initially, a dataset 200 (see FIG. 4) can be selected upon which the modeling platform can operate. In some embodiments, the dataset 200 can be pre-generated and can be retrieved from various locations, such as a local computer or database, a remote server, and so forth. The dataset 200 can contain any variety of data. For example, the dataset 200 can contain data derived from a series of measurements (e.g., sensor data) relating to a particular industrial machine. It is understood, however, that the data contained within any given dataset 200 is not limited thereto.

In addition, the data contained in the dataset 200 can be divided into one or more categories. For example, the dataset 200 can be divided into two categories: training data used for training analytics models, and testing data used for testing and verifying trained analytics models. The training data and testing data will be described in greater detail below.

After selection of the dataset 200, the GUI 100 can display a data tag field 102 of data tags within the dataset 200. The data tags can correspond to data contained in the dataset 200. More specifically, each data tag can represent a name or title of the corresponding data contained in the dataset 200. The data tags can consist of characters, numbers, symbols, or any combination thereof. As shown, the data tag selection field 102 can include a “Name” column indicating the name of each data tag in the dataset 200, and an “Absolute Correlation” (or “Abs. Corr.”) indicating the absolute correlation of each available data tag.

Using the data tag selection field 102, a user can select specific data tags for use in building analytics models. The GUI 100 can present the user with the ability to select desired data tags in any suitable manner, such as a check box, a button, a slider, or the like.

The correlation matrix 106 can assist the user in selecting the optimal data tags for analytics model building. In detail, the correlation matrix 106 can represent a mathematical expression of the correlation between each data tag in the dataset 200. The correlation between data tags can indicate how one or more data tags in the data set relates to each other, as well as the degree to which changing a data tag can affect another data tag.

The amount of correlation can be illustrated in various ways. For example, in some embodiments, the correlation can be depicted as a color within a color scale or a shading within a shading scale, as shown in FIG. 1. In other embodiments, the correlation can be illustrated by numerical values. A higher coefficient between data tags can indicate that one data tag can be utilized to predict another data tag, whereas a lower coefficient between data tags can indicate that one data tag is unlikely to be successful in predicting another data tag.

In another example, semantic knowledge can be used to calculate the correlation between data tags. For instance, using the semantic model database 300 (see FIG. 4), the modeling platform can evaluate the data tag labels (e.g., “vTcd_reg,” “STARTS,” “HSR,” “HOURS,” etc.) to estimate the likely correlation between different data tags. The modeling platform may recognize, for example, that the data tag “HOURS” corresponds to data relating to time. Thus, the modeling platform can estimate that the correlation between the data tag “HOURS” and another data tag associated with time data is high.

The GUI 100 can further include an analytics model building technique selection field 104. Each of the analytics model building techniques listed in the analytics model building technique selection field 104 can be predefined. Various analytics model building techniques are known in the art, and any suitable analytics model building technique can be listed including, but not limited to, regression techniques and variations thereof.

Using the analytics model building technique selection field 104, the user can select any number of analytics model building techniques. Each selected analytics model building technique can be utilized to build an analytics model. Thus, as the number of analytics model building techniques selected in the analytics model building technique selection field 104 increases, the number of analytics models generated can also increase.

Supplemental information fields 108 and 110 can display additional information relating to the selected data tags, the selected analytics model building techniques, or any other collection of information relating to the utilized data set, analytics model building technique, or so forth.

Upon selecting data tags and analytics model building techniques in the manner described above, the user can initiate the building of a plurality of analytics models by selecting the activate build feature 112. The activate build feature 112 can be a button, as shown in FIG. 1, or any other suitable GUI feature.

Upon activating the activate build feature 112, the modeling platform can automatically build a plurality of analytics models. The analytics models can be trained using the data corresponding to the selected data tags according to machine learning, deep learning, and/or hybrid physics techniques known in the art. More specifically, the data corresponding to the selected data tags can be categorized into training data and testing data, as mentioned before, and the analytics models can be trained using the training data among the data corresponding to the selected data tags. In the example of FIG. 1, the data tags used for training the analytics models are shown as including “vTcd_reg,” “STARTS,” “HSR,” “HOURS,” and “CTD.”

Furthermore, the analytics models can be built using the selected analytics model building techniques. Each selected analytics model building technique can be used to build at least one analytics model. In the example of FIG. 1, the analytics model building technique used for building the analytics models are shown as including “regression,” “pce,” “bhm,” and “ann.”

Each built analytics model can vary based on the selected data tags for training and testing the modes, and based on the selected analytics model building techniques. Based on the particular application, certain analytics model building techniques may be more effective than others in building accurate analytics models. When evaluating the performance of analytics model manually, as is conventionally performed, the process can be difficult and time-consuming. However, the modeling platform discussed herein can automate the evaluation process and significantly reduce model evaluation time by providing the user with graphical comparisons indicating the best (and worst) performing analytics models given a particular application.

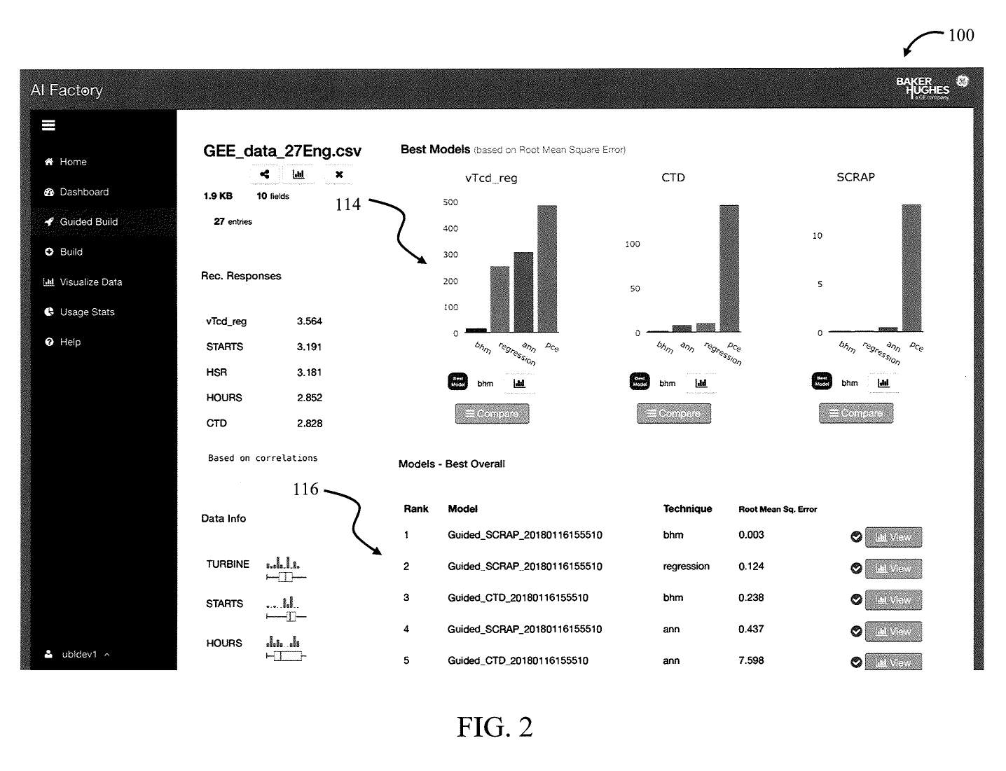

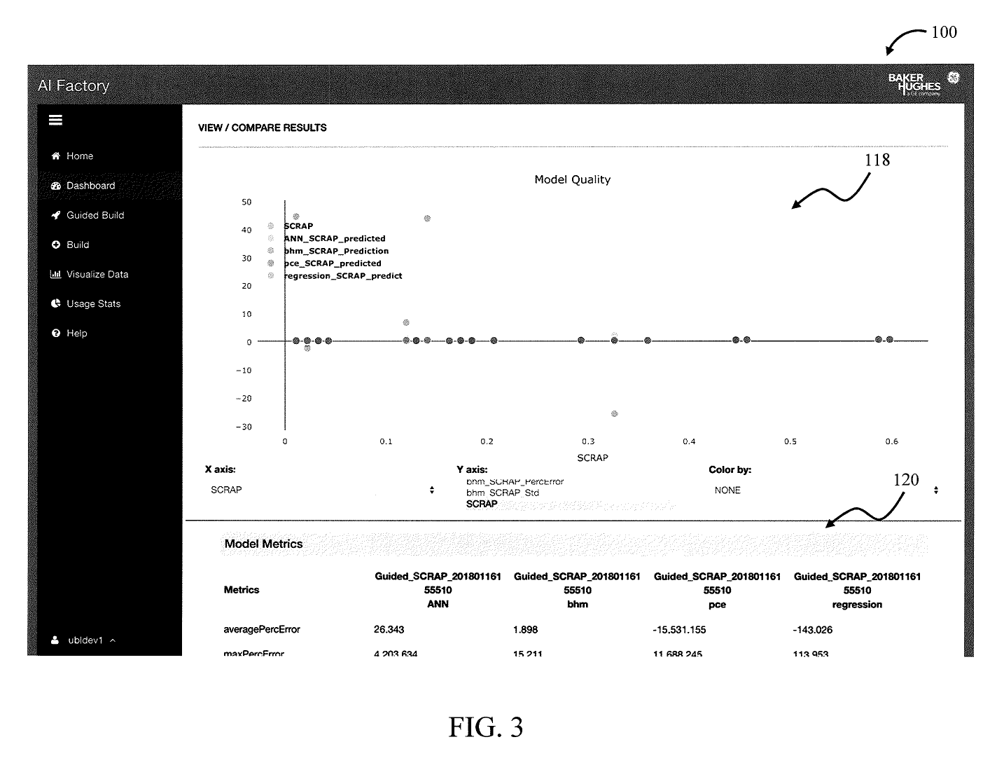

In this regard, FIG. 2 is a first exemplary layout of the GUI 100 displaying a comparison of the generated analytics models, and FIG. 3 is a second exemplary layout of the GUI 100 displaying a comparison of the generated analytics models. After building the plurality of analytics models, the modeling platform can calculate a performance of each of the plurality of analytics models using data in the dataset 200 corresponding to the selected data tags. The data corresponding to the selected data tags can be categorized into training data and testing data, as mentioned before, and the analytics models can be tested using the tested data among the data corresponding to the selected data tags.

The performance of the built analytics models can be determined based on various parameters. In one example, the likelihood of error (e.g., root mean square error (RMSE)) of each analytics model can be calculated, whereby analytics models with a lower RMSE are more likely to perform accurately and thus ranked higher than analytics models with a higher RMSE.

In this regard, the GUI 100 can display a variety of visualizations to demonstrate relative performance amongst all built analytics models. For example, the GUI 100 can display an analytics model comparison bar chart 114 that compares the performance of analytics models built in the manner described above. Particularly, the bar chart 114 can illustrate the RMSE of analytics models built using each selected analytics model building technique with respect to each selected data tag. In the example of FIG. 2, it is shown that the analytics model built using the analytics model building technique “bhm” has the lowest RMSE for the data tag “vTcd_reg,” the analytics model built using the analytics model building technique “bhm” has the lowest RMSE for the data tag “CTD,” and the analytics models built using the analytics model building techniques “bhm” and “regression” have the lowest RMSEs for the data tag “SCRAP.” This visualization can enable the user to quickly understand the most effective analytics model building techniques based on specific data tags.

Similarly, the GUI 100 can display an analytics model comparison table 116 providing similar insight. In the analytics model comparison table 116, each built analytics model can be numerically ranked based on its calculated RMSE. The analytics model comparison table 116 can indicate the name of each analytics model, the technique used to build the analytics model, and the RMSE of the analytics model. Furthermore, the analytics model comparison table 116 can include a “View” feature in which information regarding a specific analytics model can be displayed, allowing a user to further evaluate each model in detail.

As shown in FIG. 3, the GUI 100 can display an analytics model plot graph 118 in which a user can select data tags to be assigned to the x- and y-axis respectively. Based on the selected data tags, points can be mapped on the analytics model plot graph 118 indicating the performance (e.g., RMSE) of an analytics model built using each of the selected analytics model building techniques.

Further, the GUI 100 can display an analytics model metrics table 120 showing a list of metrics associated with each built analytics model in table-form. For example, the analytics model metrics table 120 can show metrics such as average percentage error, maximum percentage error, minimum percentage error, and the like. Each of the above automatically generated comparison visualizations can be utilized by the user through the GUI 100 to quickly determine the optimal analytics model for a given dataset 200 and data tags.

FIG. 4 is a functional block diagram illustrating an exemplary operation 400 of the modeling platform. As shown, operation of the modeling platform can begin with selection of a dataset 200. The dataset 200 can be pre-generated, as noted above, and can be retrieved from various locations, such as a local computer or database, a remote server, and so forth. The dataset 200 can contain any variety of data. For example, the dataset 200 can contain data derived from a series of measurements (e.g., sensor data) relating to a particular industrial machine.

The modeling platform operation can proceed to section 402 whereby the user can be presented with data tags for training and testing of analytics models based on the selected dataset through the GUI 100. The modeling platform can automatically evaluate the correlations between each of the available data tags. For example, semantic knowledge can be used to calculate a correlation coefficient between data tags. Using the semantic model database 300, the modeling platform can evaluate the data tag labels (e.g., “vTcd_reg,” “STARTS,” “HSR,” “HOURS,” etc.) to estimate the likely correlation between different data tags. The semantic model database 300 can be updated during operation to include information learned regarding the usage of particular data tags. After automatic evaluation of the data tags, the user can select or validate the available data tags to be used in building the analytics models.

The modeling platform operation can proceed to section 404 whereby the modeling platform can automatically select input and output variable groups among the selected data tags. The input and output data selected by the modeling platform can vary according to the analytics model building techniques utilized.

The modeling platform operation can proceed to section 406 whereby the user can be presented with analytics model building techniques for building analytics models using the selected data tags as training and testing data through the GUI 100. Various analytics model building techniques are known in the art, and any suitable analytics model building technique can be listed including, but not limited to, regression techniques and variations thereof. The modeling platform can automatically suggest one or more optimal analytics model building techniques based on the selected data tags using information stored in the semantic model database 300. The user can validate the suggested analytics model building techniques, or select a technique among any of the available analytics model building techniques.

The modeling platform operation can proceed to section 408 whereby the modeling platform can build a plurality of analytics models using the analytics model building techniques selected in section 408. The data tags selected in section 402 can be used to train and test the analytics models.

Each analytics model building technique can be used to build at least one analytics model. As the number of analytics model building techniques increases, the number of analytics models can also increase. Thus, the building of analytics models can be performed in parallel, as shown in FIG. 4. Similarly, the performance evaluation of all analytics models can be performed in parallel, thereby optimizing performance of the modeling platform.

The subject matter described herein provides many technical advantages. For example, in some implementations, the current subject matter provides an autonomous platform for the analytics developers to explore their datasets in a single unified platform, avoiding silo analytics implementations and deployments. Each analytic can provide autonomously a performance metric, helping the developers to understand and rank the most suitable technique to solve the modeling problem.

In some implementations, the current subject matter can be advantageous in that it can include leveraging of cloud deployment for parallelizing model builds; leveraging infrastructure of a scalable federated hybrid analytics and machine learning platform in an autonomous fashion; and/or reduction of model build and deploy times from several months to a few minutes. In some implementations, the current subject matter includes an autonomous modeling platform in cloud environment, allowing users to more expediently generate advanced analytics models and deploy them, with no coding required.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving, via a graphical user interface (GUI), a selection of one or more data tags of a dataset, the data tags corresponding to data in the dataset, the data including training data and testing data;
receiving, via the GUI, a selection of one or more analytics model building techniques;
building, by a data processor, a plurality of analytics models using the training data, wherein each of the one or more selected analytics model building techniques is used to build at least one analytics model;
after building the plurality of analytics models, calculating, by the data processor, a performance of each of the plurality of analytics models using the testing data; and
displaying, via the GUI, a comparison of each of the plurality of analytics models based on the calculated performance of each of the plurality of analytics models.
